(19) United States
(12) Patent Application Publication
(10) Pub. No.: US 2006/0225930 A1
(43) Pub. Date: Oct. 12, 2006

(54) Dual axle electric motor drive and method of use

(76) Inventor: Juergen J. Schulte, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/176,120

(22) Filed: Jul. 7, 2005

Related U.S. Application Data
(60) Provisional application No. 60/669,559, filed on Apr. 7, 2005.

(51) Int. Cl. B60K 6/00

(52) U.S. Cl. 180/65.4; 903/906; 903/925

(57) ABSTRACT

A method of propelling a heavy-duty series hybrid vehicle including a first wheel driven by a first shaft and a second wheel driven by a second shaft includes independently driving the first shaft with a first electric motor; and independently driving the second shaft with a separate, second electric motor. Flexible joint shafts may be provided for independent wheel suspension and to allow for separate isolation mounts for the motors and gear boxes.

### CROSS-REFERENCE TO RELATED APPLICATIONS

This application claims the benefit of U.S. Provisional application Ser. No. 60/669,559 filed Apr. 7, 2005 under 35 U.S.C. 119(e). The drawings and disclosure of U.S. application Ser. No. 60/669,559 are hereby incorporated by reference as though set forth in full.

### FIELD OF THE INVENTION

The field of the invention relates to drive subsystems (e.g., electric drive motors, motor controller, gear reduction system, driveline, and related components) for heavy-duty series hybrid vehicles.

### BACKGROUND OF THE INVENTION

The standard design of a driven axle (with two wheels) of a heavy-duty vehicle incorporates a differential gear box that has ring and pinion gears with some ratio to reduce the RPMs from a rotating input drive shaft mounted at some angle to the driven axle. As used herein, a heavy-duty vehicle refers to a vehicle with a gross vehicle weight rating (GVWR) of at least 10,000 pounds. The differential also incorporates a box gear transfer from the ring gear to the driven axle that allows the wheels to turn at different speeds without dragging one wheel when the vehicle is turning. This design is almost universally used in rear axle drive vehicles.

However, when more than one rotating power source is available for the vehicle propulsion, as in an electrically powered vehicle with multiple drive motors, the driven wheels can be powered independently without an interconnected differential. Electric wheel motors have been proposed in the past, but usually result in a large massive wheel with questionable ruggedness, reliability and endurance. Repeated 30 g shocks introduced into these motors, combined with the heat of the adjacent brake systems, cause accelerated motor mechanical and bearing wear.

### SUMMARY OF THE INVENTION

An aspect of the present invention involves an axle drive assembly where the drive motors are built into the axles. In the axle drive assembly, the differential part of the axles (and associated weight) are eliminated and replaced with two standard electric drive motors. The axle drive assembly offers the advantage of using the same basic type of motors currently used in electric drive systems, without having to alter the suspension, braking system, or wheel hub of the heavy-duty vehicle.

Another aspect of the invention involves a method of propelling a heavy-duty series hybrid vehicle including a first wheel driven by a first shaft and a second wheel driven by a second shaft. The method includes independently driving the first shaft with a first electric motor; and independently driving the second shaft with a separate, second electric motor.

A further aspect of the invention involves an axle drive assembly for a heavy-duty series hybrid vehicle including opposite first and second wheels. The axle drive assembly includes a first shaft for driving the first wheel of the heavy-duty series hybrid vehicle; a second shaft for driving the second wheel of the heavy-duty series hybrid vehicle; a first electric motor coupled to the first shaft for independently driving the first shaft; and a separate, second electric motor coupled to the second shaft for independently driving the second shaft.

### BRIEF DESCRIPTION OF THE DRAWINGS

The accompanying drawings, which are incorporated in and form part of this specification, illustrate an embodiment of the invention and together with the description, serve to explain the principles of this invention.

FIG. 1 is a simple schematic of an embodiment of an axle drive assembly for a heavy-duty series hybrid vehicle.

FIG. 2 is a simple schematic of another embodiment of an axle drive assembly for a heavy-duty series hybrid vehicle.

### DETAILED DESCRIPTION OF A PREFERRED EMBODIMENT

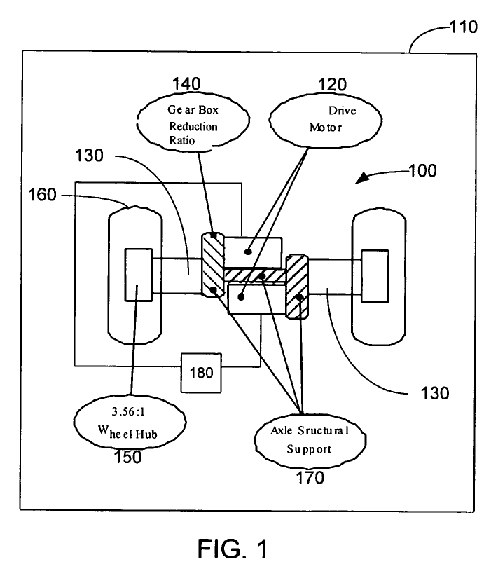

With reference to FIG. 1, an embodiment of an axle drive assembly 100 for a heavy-duty series hybrid vehicle 110 will now be described. Although the axle drive assembly 100 will be described in conjunction with a heavy-duty series hybrid vehicle 110, the axle drive assembly 100 may be used with other types of vehicles. Further, although the axle drive assembly 100 will be shown and described as independently driving first and second rear wheels though respective first and second axles, each axle may independently drive more than one wheel and/or the driven wheel(s) may be located anywhere along the length of the vehicle (e.g., front, rear, middle).

The axle drive assembly 100 includes a pair of independent electric drive motors 120 that drive independent axles 130 through respective gear boxes 140. Each gear box 140 includes a gear assembly with an appropriate reduction ratio for rotating the axle 130 at an appropriate RPM when driven by the motor 120. Each independent axle 130 rotates wheel hub 150, which, in turn, causes wheel 160 to rotate. The axles 130, gear boxes 140, and motors 120 are supported by an axle structural support assembly 170. A motor controller 180 controls the motors 120 for controlling the RPM of the axle 130. In certain situations, such as when turning, it is desirable for one wheel 160 to rotate faster than the other wheel 160. The motor controller 180 independently controls the speed and/or torque of the each motor 120, which controls the rotational speed of each wheel 160, for such situations.

The axle drive assembly 100 is advantageous in that, among other things, it eliminates the need for the interconnected differential in a heavy-duty vehicle, greatly reducing the weight of the drive system. The axle drive assembly 100 also takes advantage of the multiple drive motors available in a heavy-duty series hybrid vehicle 110. Compared to electric wheel motors, the axle drive assembly 100 has greater ruggedness, reliability and endurance.

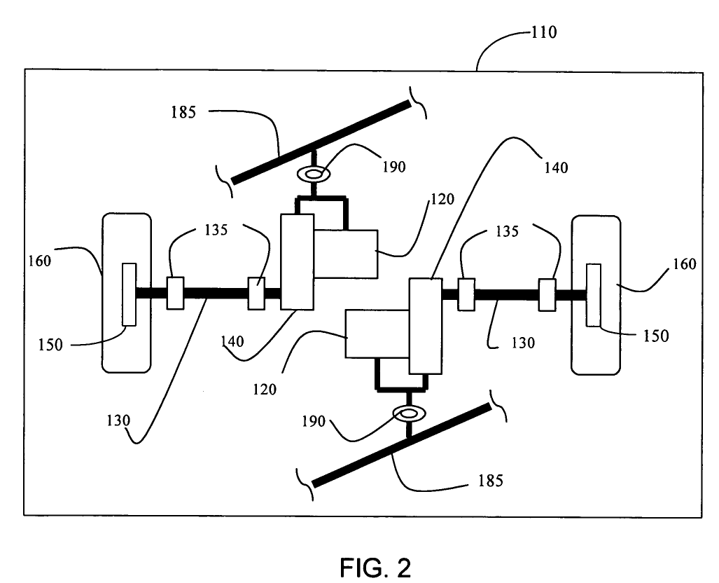

With reference to FIG. 2, to enhance the vehicle suspension performance and to further increase the ruggedness, reliability, and endurance of the drive components, in an alternative embodiment of vehicle 110, the axle drive connection 130 is a propeller shaft with flexible joints 135 near each end. The flexible joints 135 allow the wheel hubs 150 and wheels 160 to be suspended independently from the electric motors 120 and the gearboxes 140. Thus, the electric motor 120 and gearbox 140 can be attached to the sprung weight of the vehicle frame 185 in isolation from the shock and vibration of the wheel hub 150 and wheel 160. Furthermore, the electric motor 120 and gearbox 140 can have their own isolation mounts 190 to the vehicle frame 185 for more cushioning and to prevent unwanted noise and vibration from transmitting into the vehicle frame 185.

The propeller shaft 130 can be of any design that transmits the rotational torque between the gearbox 140 and the wheel hub 150. One example of this propeller shaft is a hollow metal torque tube with universal joints at each end.

While the particular devices and methods herein shown and described in detail are fully capable of attaining the above described objects of this invention, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art having the benefit of this disclosure and that the scope of the present invention is accordingly limited by nothing other than the appended claims.

What is claimed is:

1. A method of propelling a heavy-duty series hybrid vehicle, the heavy-duty series hybrid vehicle including a first wheel driven by a first shaft and a second wheel driven by a second shaft, comprising:
independently driving the first shaft with a first electric motor;
independently driving the second shaft with a separate, second electric motor.

2. The method of claim 1, further including a first gear box coupling the first electric motor and the first shaft and a second gear box coupling the second electric motor and the second shaft, and independently driving the first shaft includes independently driving the first shaft with the first electric motor through the first gear box, and independently driving the second shaft includes independently driving the second shaft with the second electric motor through the second gear box.

3. The method of claim 1, further including a controller for independently controlling the first electric motor and the second electric motor, and the method further includes independently controlling at least one of the speed and torque of the first electric motor with the controller and independently controlling at least one of the speed and torque of the second electric motor with the controller.

4. The method of claim 3, wherein the controller causes the first motor to operate at a first speed and the second motor to operate at a second speed, and the first speed and the second speed are different.

5. The method of claim 1, wherein the shafts have opposite ends and flexible joints near the ends of the shafts.

6. The method of claim 1, wherein the heavy-duty series hybrid vehicle includes a vehicle frame and isolation mounts connecting the vehicle frame to the motors.

7. The method of claim 1, wherein the first wheel includes a first wheel hub and the second wheel includes a second wheel hub, the shafts include opposite ends, and the first shaft is a first propeller shaft with flexible coupling joints near each end coupled between the first electric motor and the first wheel hub, and the second shaft is a second propeller shaft with flexible coupling joints near each end coupled between the second electric motor and the second wheel hub.

8. The method of claim 1, further including a first gear box coupling the first electric motor and the first shaft and a second gear box coupling the second electric motor and the second shaft, the first shaft is a first propeller shaft with flexible coupling joints near each end coupled between a first gear box and the first propeller shaft, and the second shaft is a second propeller shaft with flexible coupling joints near each end coupled between a second gear box and the second propeller shaft.

9. The method of claim 1, wherein the heavy-duty series hybrid vehicle includes a vehicle frame, a first gear box coupling the first electric motor and the first shaft, a second gear box coupling the second electric motor and the second shaft, and isolation mounts connecting the vehicle frame to the first motor and first gear box, and the second motor and second gear box.

10. A axle drive assembly for a heavy-duty series hybrid vehicle, the heavy-duty series hybrid vehicle including opposite first and second wheels, comprising:
a first shaft for driving the first wheel of the heavy-duty series hybrid vehicle;
a second shaft for driving the second wheel of the heavy-duty series hybrid vehicle;
a first electric motor coupled to the first shaft for independently driving the first shaft; and
a separate, second electric motor coupled to the second shaft for independently driving the second shaft.

11. The axle drive assembly of claim 10, further including a first gear box coupling the first electric motor and the first shaft and a second gear box coupling the second electric motor and the second shaft.

12. The axle drive assembly of claim 10, further including a controller coupled to the first electric motor and the second electric motor for independently controlling the first electric motor and the second electric motor.

13. The axle drive assembly of claim 12, wherein the controller is configured to cause the first motor to operate at a first speed and the second motor to operate at a second speed, and the first speed and the second speed are different.

14. The axle drive assembly of claim 10, wherein the shafts have opposite ends and flexible joints near the ends of the of the shafts.

15. The axle drive assembly of claim 10, wherein the heavy-duty series hybrid vehicle includes a vehicle frame and isolation mounts connecting the vehicle frame to the motors.

16. The axle drive assembly of claim 10, wherein the first wheel includes a first wheel hub and the second wheel includes a second wheel hub, the shafts include opposite ends, and the first shaft is a first propeller shaft with flexible coupling joints near each end coupled between the first electric motor and the first wheel hub, and the second shaft is a second propeller shaft with flexible coupling joints near each end coupled between the second electric motor and the second wheel hub.

17. The axle drive assembly of claim 10, further including a first gear box coupling the first electric motor and the first shaft and a second gear box coupling the second electric motor and the second shaft, the first shaft is a first propeller shaft with flexible coupling joints near each end coupled between a first gear box and the first propeller shaft, and the second shaft is a second propeller shaft with flexible coupling joints near each end coupled between a second gear box and the second propeller shaft.

18. The axle drive assembly of claim 10, wherein the heavy-duty series hybrid vehicle includes a vehicle frame, a first gear box coupling the first electric motor and the first shaft, a second gear box coupling the second electric motor and the second shaft, and isolation mounts connecting the vehicle frame to the first motor and first gear box, and the second motor and second gear box.
